(19) United States
(12) Patent Application Publication
(10) Pub. No.: US 2025/0365739 A1
(43) Pub. Date: Nov. 27, 2025

(54) METHOD AND APPARATUS FOR ENHANCEMENTS ON PHYSICAL DOWNLINK CONTROL CHANNEL SKIPPING AND SEARCH SPACE SET GROUP SWITCHING

(71) Applicant: MEDIATEK INC., Hsinchu City (TW)

(72) Inventors: Chi-Hsuan HSIEH, Hsinchu City (TW); Yi-Chia LO, Hsinchu City (TW); Wei-De WU, Hsinchu City (TW)

(21) Appl. No.: 18/872,364

(22) PCT Filed: Jun. 27, 2023
(86) PCT No.: PCT/CN2023/102591

§ 371 Date: Dec. 6, 2024

Related U.S. Application Data
(60) Provisional application No. 63/371,234, filed on Aug. 12, 2022.

(51) Int. Cl. H04W 72/231; H04W 72/0457; H04W 72/12; H04W 74/0833; H04W 76/28

(52) U.S. Cl. CPC H04W 72/231; H04W 72/0457; H04W 72/12; H04W 74/0833; H04W 76/28

(57) ABSTRACT

Various solutions for enhancements on physical downlink control channel (PDCCH) skipping and search space set group (SSSG) switching are described. An apparatus may detect a downlink control information (DCI) format from a network node of a wireless network. The DCI format indicates a duration for skipping PDCCH monitoring. The apparatus may skip PDCCH monitoring for the duration on an active downlink (DL) bandwidth part (BWP) of a serving cell. The apparatus may terminate skipping PDCCH monitoring in an event that at least one condition is met.

### CROSS REFERENCE TO RELATED PATENT APPLICATION(S)

The present disclosure is part of a non-provisional application claiming the priority benefit of U.S. patent application Ser. No. 63/371,234, filed 12 Aug. 2022, the content of which herein being incorporated by reference in its entirety.

### TECHNICAL FIELD

The present disclosure is generally related to mobile communications and, more particularly, to enhancements on physical downlink control channel (PDCCH) skipping and search space set group (SSSG) switching.

### BACKGROUND

Unless otherwise indicated herein, approaches described in this section are not prior art to the claims listed below and are not admitted as prior art by inclusion in this section.

Discontinuous reception (DRX) is a technique applied in wireless communication technologies, such as 4G long-term evolution (LTE) and 5G new radio (NR), to conserve system resources. In DRX operations, a user equipment (UE) generally performs wireless reception in a DRX ON duration, and switches to a power saving mode in a DRX OFF duration since the network will not be transmitting any data to the UE in the DRX OFF duration. Specifically, the UE needs to monitor the physical downlink control channel (PDCCH) in the DRX ON duration, to see if the network transmits any data to the UE. With DRX operations, the UE is allowed to go to sleep in the DRX OFF duration of each DRX cycle, which reduces the UE's power consumption.

For UEs operating in DRX operations, it is observed in the 5G NR Daily of Use (DoS) analysis that, most of the time, the PDCCH monitoring is performed without further data. That is, a UE may always monitor the PDCCH in the DRX ON duration, but the network may not have any data to transmit to the UE. Such PDCCH monitoring without further data may consume a large portion of UE's battery power, especially for the cases where data is configured with short inter-packet arrival time. Alternatively, for UEs not operating in DRX operations, the same issue of power consumption for PDCCH monitoring may occur. To solve this problem, in 3^{rd} Generation Partnership Project (3GPP) Release 17, a technique called PDCCH monitoring adaptation is introduced which allows a UE to be indicated to skip PDCCH monitoring for a duration. Moreover, a technique called search space set group (SSSG) switching is introduced which allows a UE to be indicated to switch between SSSGs with different PDCCH monitoring behaviors. However, the UE behaviors related to PDCCH skipping and SSSG switching are undefined and indeterminate in some cases where PDCCH monitoring adaptation takes place with other procedures or operations, such as random access procedure, scheduling request (SR) procedure, discontinuous reception (DRX) operation, and active bandwidth part (BWP) change.

Accordingly, how to define or determine proper UE behaviors related to PDCCH skipping and SSSG switching in such cases has become an important issue in 5G NR. Therefore, there is a need to provide proper schemes to solve this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to physical downlink control channel (PDCCH) skipping and search space set group (SSSG) switching.

In one aspect, a method may involve an apparatus detecting a downlink control information (DCI) format from a network node of a wireless network, wherein the DCI format indicates a first duration for skipping PDCCH monitoring. The method may also involve the apparatus skipping PDCCH monitoring for the first duration on an active downlink (DL) bandwidth part (BWP) of a serving cell. The method may further involve the apparatus terminating skipping PDCCH monitoring in an event that at least one condition is met.

In one aspect, an apparatus may comprise a transceiver which, during operation, wirelessly communicates with a network node of a wireless network. The apparatus may also comprise a processor communicatively coupled to the transceiver. The processor, during operation, may perform operations comprising detecting, via the transceiver, a DCI format from the network node, wherein the DCI format indicates a first duration for skipping PDCCH monitoring. The processor may also perform operations comprising skipping, via the transceiver, PDCCH monitoring for the first duration on an active DL BWP of a serving cell. The processor may further perform operations comprising terminating, via the transceiver, skipping PDCCH monitoring in an event that at least one condition is met.

In one aspect, a method may involve an apparatus detecting a DCI format from a network node of a wireless network, wherein the DCI format indicates a duration for skipping PDCCH monitoring. The method may also involve the apparatus performing PDCCH monitoring according to a configuration in a new active DL BWP of a serving cell in an event that the apparatus changes to the new active DL BWP of the serving cell by an expiration of a BWP inactive timer in the duration.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of PDCCH skipping and SSSG switching in accordance with the present disclosure.

FIG. 2 is a diagram depicting an example scenario of PDCCH monitoring adaptation taking place with other procedures or operations in accordance with the present disclosure.

FIG. 3 is a diagram depicting another example scenario of PDCCH monitoring adaptation taking place with other procedures or operations in accordance with the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhancements on physical downlink control channel (PDCCH) skipping and search space set group (SSSG) switching. According to the present disclosure, a number of possible solutions may be implemented separately or jointly. That is, although these possible solutions may be described below separately, two or more of these possible solutions may be implemented in one combination or another.

In 3^{rd} Generation Partnership Project (3GPP) Release 17, techniques called PDCCH monitoring adaptation and SSSG switching are introduced. PDCCH monitoring adaptation is also called PDCCH skipping in the 3GPP Technical Specifications (e.g., TS 38.213) and it can be applied to both Discontinuous reception (DRX) scenarios (i.e., the scenarios in which the UE is operating in DRX operations) and non-DRX scenarios (i.e., the scenarios in which the UE is not operating in DRX operations). With PDCCH monitoring adaptation, a user equipment (UE) may be indicated to skip PDCCH monitoring for a duration. With SSSG switching, a UE may be indicated to switch between SSSGs with different PDCCH monitoring behaviors. However, there are some issues/problems that may occur when applying PDCCH skipping and SSSG switching. More specifically, the UE behaviors related to PDCCH skipping and SSSG switching are undefined and indeterminate in some cases where PDCCH monitoring adaptation takes place with other procedures or operations, such as random access procedure, scheduling request (SR) procedure, discontinuous reception (DRX) operation, and active bandwidth part (BWP) change.

In view of the above, the present disclosure proposes a number of schemes pertaining to enhancements on PDCCH skipping and SSSG switching. According to some schemes of the present disclosure, a UE may terminate skipping PDCCH monitoring when certain condition(s) is/are met, e.g., when an SR is pending, when a random access response (RAR) window, a message-B (MsgB) window, or a contention resolution timer is started, or when the time is outside the DRX active time of a DRX group configured for the serving cell. Moreover, according to some schemes of the present disclosure, when a UE changes to a new active downlink (DL) BWP of a serving cell by the expiration of a BWP inactive timer in the duration for skipping PDCCH monitoring, the UE may apply the PDCCH monitoring behavior (i.e., perform PDCCH monitoring) according to the configuration in the new active DL BWP of the serving cell. Accordingly, by applying the schemes of the present disclosure, the UE behaviors related to PDCCH skipping and SSSG switching are properly defined to allow the UE and the network node to be synchronized in the cases where PDCCH monitoring adaptation takes place with other procedures or operations.

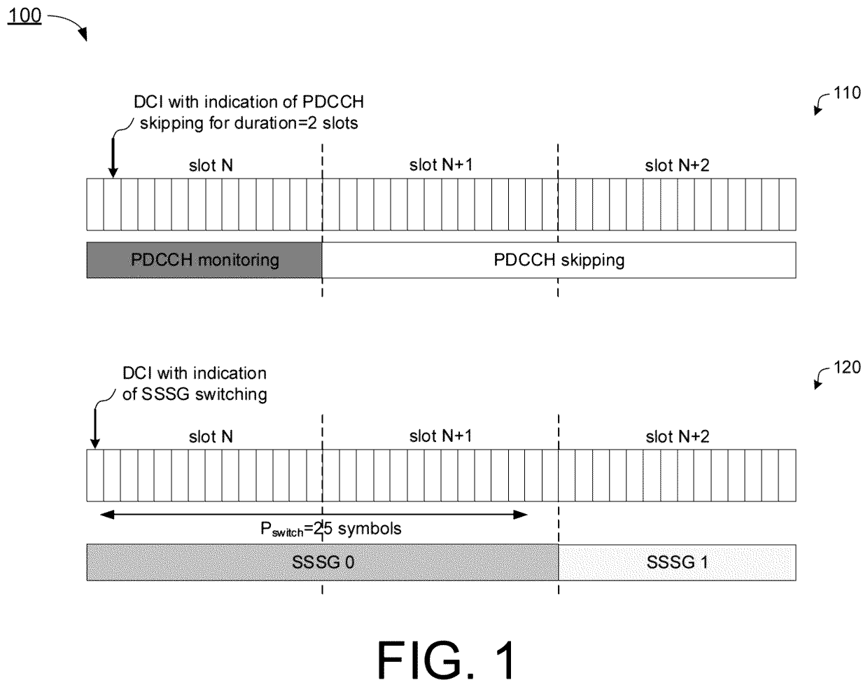

FIG. 1 illustrates an example scenario 100 of PDCCH skipping and SSSG switching in accordance with the present disclosure. In scenario 100, it is assumed that the frame structure is compliant with 5G NR with the subcarrier spacing (SCS)=30 KHz (i.e., numerology (μ)=1) and the UE processing capability=1. Top diagram 110 depicts a case of PDCCH skipping, while bottom diagram 120 depicts a case of SSSG switching. In diagram 110, after receiving a DCI (e.g., DCI format 0_1/1_1/0_2/1_2) with an indication of PDCCH skipping (e.g., a PDCCH monitoring adaptation field indicates a PDCCH skipping duration=2 slots), the UE skips or stops PDCCH monitoring in the indicated PDCCH skipping duration. Note that the indicated monitoring behavior is applied at slot boundary. In diagram 120, after receiving a DCI (e.g., DCI format 0_1/1_1/0_2/1_2) with an indication of SSSG switching (e.g., a PDCCH monitoring adaptation field indicates to the UE to start PDCCH monitoring according to search space sets with a first group index (e.g., 1) and stop PDCCH monitoring according to search space sets with a second group index (e.g., 0)), the UE applies the indication at the beginning of a first slot that is at least P_{switch} (e.g., P_{switch}=25) symbols after the last symbol of the PDCCH reception providing the DCI format with the indication when μ∈{0, 1, 2, 3}. Alternatively, the UE applies the indication at the beginning of a first slot, of a slot group of Xₛ slots, that is at least P_{switch} symbols after the last symbol of the PDCCH reception providing the DCI format with the indication when μ∈{5, 6}. Note that the indicated monitoring behavior is also applied at slot boundary.

It is noteworthy that, according to some schemes of the present disclosure, the minimum value of P_{switch} as defined in TS 38.213 is extended from 40 symbols to 50/45/44/43/42/41 symbols for μ=3 when operated with pdcch-SkippingDurationList-r17 or searchSpaceGroupIdList-r17 or searchSpaceSwitchTimer-r17, such that the UE may be allowed to have more processing time for PDCCH monitoring adaptation.

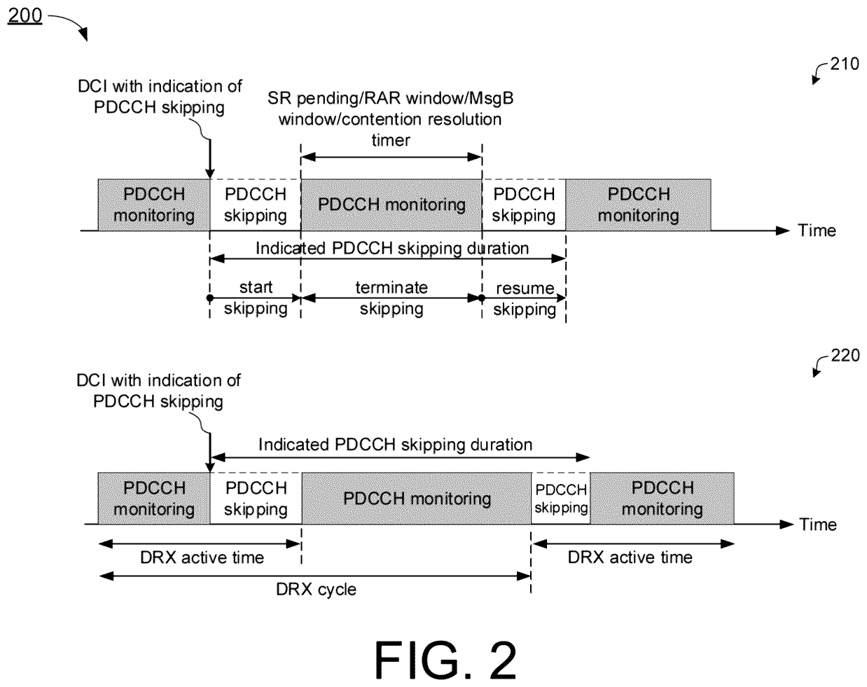

FIG. 2 illustrates an example scenario 200 of PDCCH monitoring adaptation taking place with other procedures or operations in accordance with the present disclosure. In scenario 200, top diagram 210 depicts PDCCH monitoring adaptation taking place with SR or RA procedure, while bottom diagram 220 depicts PDCCH monitoring adaptation taking place with DRX operation. In diagram 210, after receiving a DCI (e.g., DCI format 0_1/1_1/0_2/1_2) with an indication of PDCCH skipping (e.g., a PDCCH monitoring adaptation field indicates a PDCCH skipping duration), the UE skips or stops PDCCH monitoring in the indicated PDCCH skipping duration. Next, an event that at least one condition is met occurs in the indicated PDCCH skipping duration. More specifically, the condition indicates that an SR is pending, or that a random access response (RAR) window, a message-B (MsgB) window, or a contention resolution timer is started. In response to the event occurring in the indicated PDCCH skipping duration, the UE terminates skipping PDCCH monitoring until the condition is released and then resumes skipping PDCCH monitoring if the indicated PDCCH skipping duration is not over. In diagram 220, after receiving a DCI (e.g., DCI format 0_1/1_1/0_2/1_2) with an indication of PDCCH skipping (e.g., a PDCCH monitoring adaptation field indicates a PDCCH skipping duration), the UE skips or stops PDCCH monitoring in the indicated PDCCH skipping duration. Next, an event that at least one condition is met occurs in the indicated PDCCH skipping duration. More specifically, the condition indicates that the current time is outside a DRX active time of the DRX group of the serving cell. That is, PDCCH skipping only applies during the DRX active time. In response to the event occurring in the indicated PDCCH skipping duration, the UE terminates skipping PDCCH monitoring until the condition is released and then resumes skipping PDCCH monitoring if the indicated PDCCH skipping duration is not over.

Alternatively, in some implementations, if the UE transmits a PUCCH providing a positive SR before the UE detects a DCI format providing the PDCCH monitoring adaptation field indicating to the UE to skip PDCCH monitoring for the duration on the active DL BWP of the serving cell, the UE may monitor PDCCH regardless of the PDCCH skipping indication on all serving cells of the corresponding cell group when the SR is pending. That is, the skipping of PDCCH monitoring is terminated or canceled before it is even started.

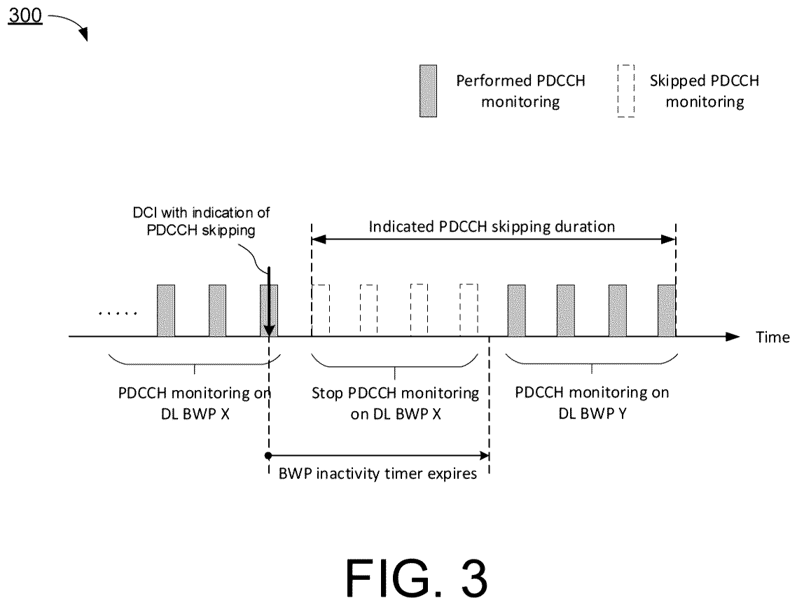

FIG. 3 illustrates another example scenario 300 of PDCCH monitoring adaptation taking place with other procedures or operations in accordance with the present disclosure. Scenario 300 depicts PDCCH monitoring adaptation taking place with active BWP change. As shown in FIG. 3, the UE performs PDCCH monitoring on an active DL BWP (denoted as DL BWP X) of the serving cell. During the PDCCH monitoring, the UE receives a DCI (e.g., DCI format 0_1/1_1/0_2/1_2) with an indication of PDCCH skipping (e.g., a PDCCH monitoring adaptation field indicates a PDCCH skipping duration). In response to the DCI format with the indication, the UE skips or stops PDCCH monitoring on the active DL BWP. Next, when a BWP inactivity timer expires in the PDCCH skipping duration, the UE changes to a new active DL BWP (denoted as DL BWP Y). In response to the active BWP change, the UE applies the indicated PDCCH monitoring behavior according to the configuration in the target BWP after the active BWP change. That is, the UE performs PDCCH monitoring on the new DL BWP according to the configuration in the new active DL BWP.

### Illustrative Implementations

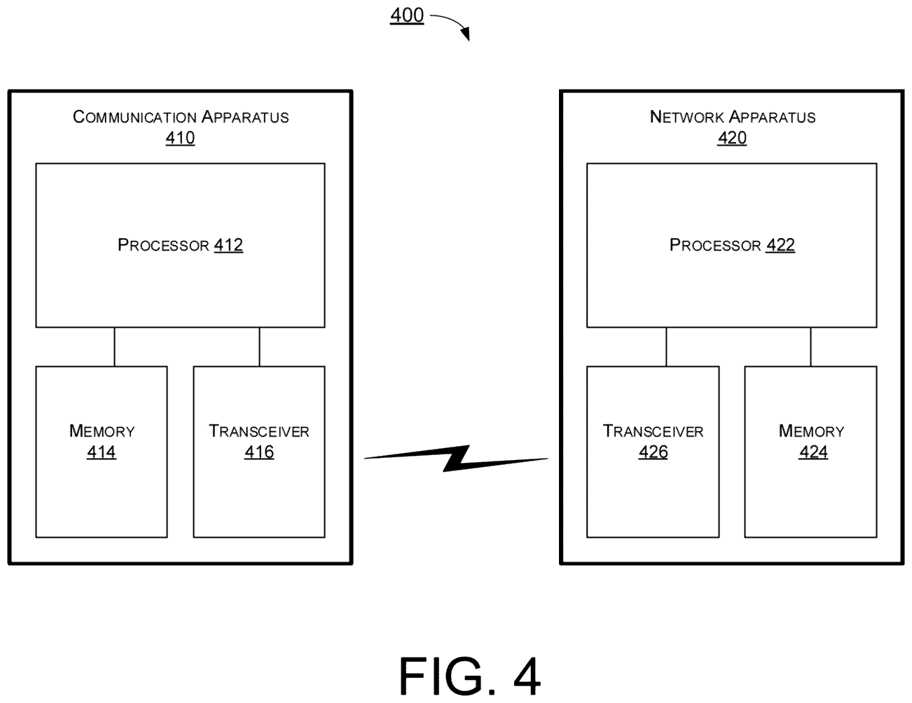

FIG. 4 illustrates an example communication system 400 having an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to enhancements on PDCCH skipping and SSSG switching, including scenarios/schemes described above as well as processes 500 and 600 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, a digital camera, or a computing equipment such as a tablet computer, a laptop computer or a notebook computer. Communication apparatus 410 may also be a part of a machine type apparatus, which may be an IoT, NB-IoT, or IloT apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of an electronic apparatus, which may be a network node such as a base station, a small cell, a router or a gateway. For instance, network apparatus 420 may be implemented in an eNodeB in an LTE, LTE-Advanced or LTE-Advanced Pro network, or in a gNB or a transmission and reception point (TRP) in a 5G NR, IoT, NB-IoT or IIoT network, or in a satellite or base station in a 6G network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including enhancements on PDCCH skipping and SSSG switching in a device (e.g., as represented by communication apparatus 410) and a network (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In some implementations, transceiver 416 may be capable of wirelessly communicating with different types of wireless networks of different radio access technologies (RATs). In some implementations, transceiver 416 may be equipped with a plurality of antenna ports (not shown) such as, for example, four antenna ports. That is, transceiver 416 may be equipped with multiple transmit antennas and multiple receive antennas for multiple-input multiple-output (MIMO) wireless communications. In some implementations, network apparatus 420 may also include a transceiver 426 coupled to processor 422 and capable of wirelessly transmitting and receiving data.

In some implementations, transceiver 426 may be capable of wirelessly communicating with different types of UEs of different RATs. In some implementations, transceiver 426 may be equipped with a plurality of antenna ports (not shown) such as, for example, four antenna ports. That is, transceiver 426 may be equipped with multiple transmit antennas and multiple receive antennas for MIMO wireless communications.

In some implementations, communication apparatus 410 may further include a memory 414 coupled to processor 412 and capable of being accessed by processor 412 and storing data therein. In some implementations, network apparatus 420 may further include a memory 424 coupled to processor 422 and capable of being accessed by processor 422 and storing data therein. Each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 410 and network apparatus 420 may be a communication entity capable of communicating with each other using various proposed schemes in accordance with the present disclosure. For illustrative purposes and without limitation, a description of operations, functionalities, and capabilities of communication apparatus 410, as a UE, and network apparatus 420, as a network node, is provided below.

Under certain proposed schemes in accordance with the present disclosure with respect to enhancements on PDCCH skipping and SSSG switching, processor 412 of communication apparatus 410, implemented in or as a UE, may detect, via transceiver 416, a DCI format from network apparatus 420. Specifically, the DCI format indicates a first duration for skipping PDCCH monitoring. Then, processor 412 may skip, via transceiver 416, PDCCH monitoring for the first duration on an active DL BWP of a serving cell. Moreover, processor 412 may terminate, via transceiver 416, skipping PDCCH monitoring in an event that at least one condition is met.

In some implementations, processor 412 may also transmit, via transceiver 416, a PUCCH providing a positive SR to network apparatus 420 before detecting the DCI format, and the at least one condition may indicate that the SR is pending. More specifically, terminating skipping PDCCH monitoring may include performing, via transceiver 416, PDCCH monitoring regardless of the first duration for skipping PDCCH monitoring.

In some implementations, processor 412 may also start a RAR window, a MsgB window, or a contention resolution timer, and the at least one condition may indicate that a time when terminating skipping PDCCH monitoring is during the RAR window or the MsgB window, or is in a second duration where the contention resolution timer is running.

In some implementations, processor 412 may also receive, via transceiver 416, a configuration of a DRX group of the serving cell from network apparatus 420, and the at least one condition may indicate that a time when terminating skipping PDCCH monitoring is outside a DRX active time of the DRX group.

In some implementations, skipping PDCCH monitoring is started at the beginning of a first slot that is after the last symbol of the detection of the DCI format.

In some implementations, the DCI format may include a PDCCH monitoring adaptation field indicating the first duration for skipping PDCCH monitoring.

In some implementations, processor 412 may also transmit, via transceiver 416, a PUCCH providing a positive SR to the network node after detecting the DCI format, and terminating skipping PDCCH monitoring may include resuming PDCCH monitoring starting at the beginning of a first slot that is after a last symbol of the PUCCH transmission.

Under certain proposed schemes in accordance with the present disclosure with respect to enhancements on PDCCH skipping and SSSG switching, processor 412 of communication apparatus 410, implemented in or as a UE, may detect, via transceiver 416, a DCI format from network apparatus 420. Specifically, the DCI format indicates a duration for skipping PDCCH monitoring. Then, processor 412 may perform, via transceiver 416, PDCCH monitoring according to a configuration in a new active DL BWP of a serving cell in an event that the apparatus changes to the new active DL BWP of the serving cell by an expiration of a BWP inactive timer in the duration.

In some implementations, performing PDCCH monitoring according to the configuration in the new active DL BWP of the serving cell may include: resuming, via transceiver 416, PDCCH monitoring according to search space sets on the new active DL BWP of the serving cell in a case that a list of search space group (IDs) (e.g., searchSpaceGroupIdList-r17) is not configured.

In some implementations, performing PDCCH monitoring according to the configuration in the new active DL BWP of the serving cell may include: monitoring, via transceiver 416, PDCCH according to search space sets with group index 0 on the new active DL BWP of the serving cell in a case that a list of search space group IDs (e.g., searchSpaceGroupIdList-r17) is configured.

In some implementations, processor 412 may also reset a SSSG timer (e.g., a search space switching timer) according to the configuration in the new active DL BWP of the serving cell in an event that the apparatus changes to the new active DL BWP of the serving cell by the expiration of the BWP inactive timer in the duration.

### Illustrative Processes

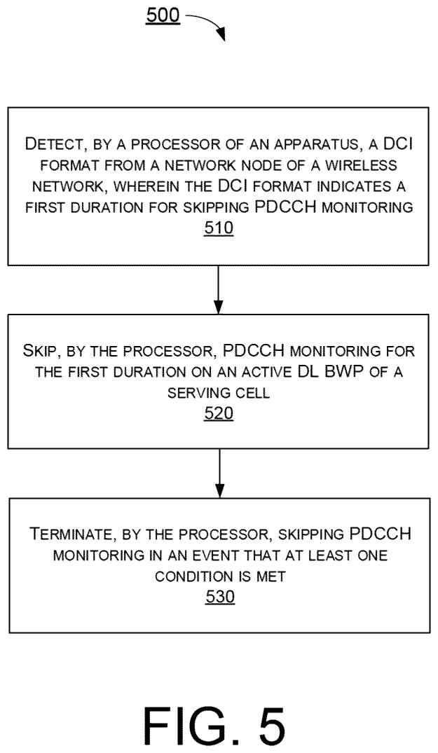

FIG. 5 illustrates an example process 500 in accordance with an implementation of the present disclosure. Process 500 may be an example implementation of above scenarios/schemes, whether partially or completely, with respect to enhancements on PDCCH skipping and SSSG switching. Process 500 may represent an aspect of implementation of features of communication apparatus 410. Process 500 may include one or more operations, actions, or functions as illustrated by one or more of blocks 510 to 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by communication apparatus 410 or any suitable UE or machine type devices. Solely for illustrative purposes and without limitation, process 500 is described below in the context of communication apparatus 410. Process 500 may begin at block 510.

At 510, process 500 may involve processor 412 of communication apparatus 410) detecting a DCI format from a network node (e.g., network apparatus 420) of a wireless network, wherein the DCI format indicates a first duration for skipping PDCCH monitoring. Process 500 may proceed from 510 to 520.

At 520, process 500 may involve processor 412 skipping PDCCH monitoring for the first duration on an active DL BWP of a serving cell. Process 500 may proceed from 520 to 530.

At 530, process 500 may involve processor 412 terminating skipping PDCCH monitoring in an event that at least one condition is met.

In some implementations, process 500 may further involve processor 412 transmitting a PUCCH providing a positive SR to the network node before detecting the DCI format, and the at least one condition may indicate that the SR is pending. The terminating of skipping PDCCH monitoring may include performing PDCCH monitoring regardless of the first duration for skipping PDCCH monitoring.

In some implementations, process 500 may further involve processor 412 starting an RAR window, a msgB window, or a contention resolution timer, and the at least one condition may indicate that a time when terminating skipping PDCCH monitoring is during the RAR window or the msgB window, or is in a second duration where the contention resolution timer is running.

In some implementations, process 500 may further involve processor 412 receiving a configuration of a DRX group of the serving cell from the network node, and the at least one condition may indicate that a time when terminating skipping PDCCH monitoring is outside a DRX active time of the DRX group.

In some implementations, skipping PDCCH monitoring is started at the beginning of a first slot that is after the last symbol of the detection of the DCI format.

In some implementations, the DCI format may include a PDCCH monitoring adaptation field indicating the first duration for skipping PDCCH monitoring.

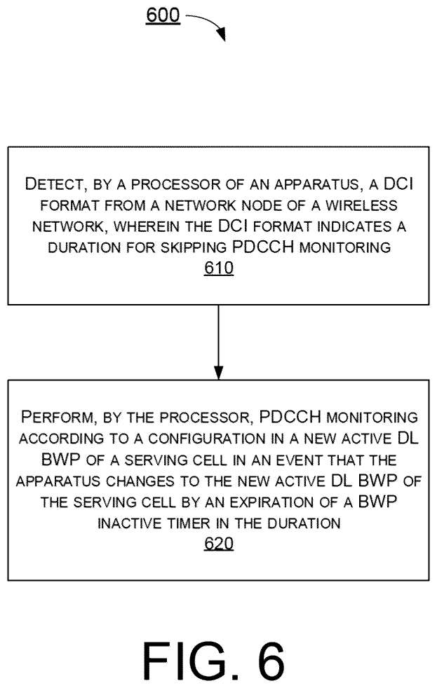

In some implementations, process 500 may further involve processor 412 transmitting a PUCCH providing a positive SR to the network node after detecting the DCI format, and terminating skipping PDCCH monitoring may include resuming PDCCH monitoring starting at the beginning of a first slot that is after a last symbol of the PUCCH transmission. FIG. 6 illustrates an example process 600 in accordance with an implementation of the present disclosure. Process 600 may be an example implementation of above scenarios/schemes, whether partially or completely, with respect to enhancements on PDCCH skipping and SSSG switching. Process 600 may represent an aspect of implementation of features of communication apparatus 410. Process 600 may include one or more operations, actions, or functions as illustrated by one or more of blocks 610 to 620. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 410 or any suitable UE or machine type devices. Solely for illustrative purposes and without limitation, process 600 is described below in the context of communication apparatus 410. Process 600 may begin at block 610.

At 610, process 600 may involve processor 412 detecting a DCI format from a network node (e.g., network apparatus 420) of a wireless network, wherein the DCI format indicates a duration for skipping PDCCH monitoring. Process 600 may proceed from 610 to 620.

At 620, process 600 may involve processor 412 performing PDCCH monitoring according to a configuration in a new active DL BWP of a serving cell in an event that communication apparatus 410 changes to the new active DL BWP of the serving cell by an expiration of a BWP inactive timer in the duration.

In some implementations, the performing of PDCCH monitoring according to the configuration in the new active DL BWP of the serving cell may include: resuming PDCCH monitoring according to search space sets on the new active DL BWP of the serving cell in a case that a list of search space group IDs (e.g., searchSpaceGroupIdList-r17) is not configured.

In some implementations, the performing of PDCCH monitoring according to the configuration in the new active DL BWP of the serving cell may include: monitoring PDCCH according to search space sets with group index 0 on the new active DL BWP of the serving cell in a case that a list of search space group IDs (e.g., searchSpaceGroupIdList-r17) is configured.

In some implementations, process 600 may further involve processor 412 resetting an SSSG timer (e.g., a search space switching timer) according to the configuration in the new active DL BWP of the serving cell in an event that the apparatus changes to the new active DL BWP of the serving cell by the expiration of the BWP inactive timer in the duration.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
detecting, by a processor of an apparatus, a downlink control information (DCI) format from a network node of a wireless network, wherein the DCI format indicates a first duration for skipping physical downlink control channel (PDCCH) monitoring;
skipping, by the processor, PDCCH monitoring for the first duration on an active downlink (DL) bandwidth part (BWP) of a serving cell; and
terminating, by the processor, skipping PDCCH monitoring in an event that at least one condition is met.

2. The method of claim 1, further comprising:
transmitting, by the processor, a physical uplink control channel (PUCCH) providing a positive scheduling request (SR) to the network node before detecting the DCI format;
wherein the at least one condition indicates that the SR is pending.

3. The method of claim 2, wherein the terminating of skipping PDCCH monitoring comprises:
performing, by the processor, PDCCH monitoring regardless of the first duration for skipping PDCCH monitoring.

4. The method of claim 1, further comprising:
starting, by the processor, a random access response (RAR) window, a message-B (MsgB) window, or a contention resolution timer;
wherein the at least one condition indicates that a time when the terminating of skipping PDCCH monitoring is during the RAR window or the MsgB window, or is in a second duration where the contention resolution timer is running.

5. The method of claim 1, further comprising:
receiving, by the processor, a configuration of a discontinuous reception (DRX) group of the serving cell from the network node;
wherein the at least one condition indicates that a time when the terminating of skipping PDCCH monitoring is outside a DRX active time of the DRX group.

6. The method of claim 1, wherein the skipping of PDCCH monitoring is started at the beginning of a first slot that is after the last symbol of the detection of the DCI format.

7. The method of claim 1, wherein the DCI format comprises a PDCCH monitoring adaptation field indicating the first duration for skipping PDCCH monitoring.

8. The method of claim 1, further comprising:
transmitting, by the processor, a physical uplink control channel (PUCCH) providing a positive scheduling request (SR) to the network node after detecting the DCI format;
wherein the terminating of skipping PDCCH monitoring comprises resuming PDCCH monitoring starting at the beginning of a first slot that is after a last symbol of the PUCCH transmission.

9. An apparatus, comprising:
a transceiver which, during operation, wirelessly communicates with a network node of a wireless network; and
a processor communicatively coupled to the transceiver such that, during operation, the processor performs operations comprising:
detecting, via the transceiver, a downlink control information (DCI) format from the network node, wherein the DCI format indicates a first duration for skipping physical downlink control channel (PDCCH) monitoring;
skipping PDCCH monitoring for the first duration on an active downlink (DL) bandwidth part (BWP) of a serving cell; and
terminating skipping PDCCH monitoring in an event that at least one condition is met.

10. The apparatus of claim 9, wherein, during operation, the processor further performs operations comprising:
transmitting, via the transceiver, a physical uplink control channel (PUCCH) providing a positive scheduling request (SR) to the network node before detecting the DCI format;
wherein the at least one condition indicates that the SR is pending.

11. The apparatus of claim 10, wherein, in terminating skipping PDCCH monitoring, the processor further performs operations comprising:
performing, via the transceiver, PDCCH monitoring regardless of the first duration for skipping PDCCH monitoring.

12. The apparatus of claim 9, wherein, during operation, the processor further performs operations comprising:
starting a random access response (RAR) window, a message-B (MsgB) window, or a contention resolution timer;
wherein the at least one condition indicates that a time when the terminating of skipping PDCCH monitoring is during the RAR window or the MsgB window, or is in a second duration where the contention resolution timer is running.

13. The apparatus of claim 9, wherein, during operation, the processor further performs operations comprising:
receiving, via the transceiver, a configuration of a discontinuous reception (DRX) group of the serving cell from the network node;
wherein the at least one condition indicates that a time when the terminating of skipping PDCCH monitoring is outside a DRX active time of the DRX group.

14. The apparatus of claim 9, wherein the skipping of PDCCH monitoring is started at the beginning of a first slot that is after the last symbol of the detection of the DCI format.

15. The apparatus of claim 9, wherein the DCI format comprises a PDCCH monitoring adaptation field indicating the first duration for skipping PDCCH monitoring.

16. The apparatus of claim 9, wherein, during operation, the processor further performs operations comprising:
transmitting, via the transceiver, a physical uplink control channel (PUCCH) providing a positive scheduling request (SR) to the network node after detecting the DCI format;
wherein, in terminating skipping PDCCH monitoring, the processor resumes the PDCCH monitoring starting at the beginning of a first slot that is after a last symbol of the PUCCH transmission.

17. A method, comprising:
detecting, by a processor of an apparatus, a downlink control information (DCI) format from a network node of a wireless network, wherein the DCI format indicates a duration for skipping physical downlink control channel (PDCCH) monitoring; and
performing, by the processor, PDCCH monitoring according to a configuration in a new active downlink (DL) bandwidth part (BWP) of a serving cell in an event that the apparatus changes to the new active DL BWP of the serving cell by an expiration of a BWP inactive timer in the duration.

18. The method of claim 17, wherein the performing of PDCCH monitoring according to the configuration in the new active DL BWP of the serving cell comprises:
resuming, by the processor, PDCCH monitoring according to search space sets on the new active DL BWP of the serving cell in a case that a list of search space group identities (IDs) is not configured.

19. The method of claim 17, wherein the performing of PDCCH monitoring according to the configuration in the new active DL BWP of the serving cell comprises:
monitoring, by the processor, PDCCH according to search space sets with group index 0 on the new active DL BWP of the serving cell in a case that a list of search space group identities (IDs) is configured.

20. The method of claim 17, further comprising:
resetting, by the processor, a search space set group (SSSG) timer according to the configuration in the new active DL BWP of the serving cell in an event that the apparatus changes to the new active DL BWP of the serving cell by the expiration of the BWP inactive timer in the duration.
